(19) United States
(12) Patent Application Publication
(10) Pub. No.: US 2024/0274317 A1
(43) Pub. Date: Aug. 15, 2024

(54) FLAT CABLE

(71) Applicant: Proterial, Ltd., Tokyo (JP)

(72) Inventors: Masashi MORIYAMA, Tokyo (JP); Detian HUANG, Tokyo (JP); Masanori KOBAYASHI, Tokyo (JP)

(21) Appl. No.: 18/414,922

(22) Filed: Jan. 17, 2024

(30) Foreign Application Priority Data
Feb. 9, 2023 (JP) 2023-018786

(51) Int. Cl. H01B 7/08; H01B 7/02; H01B 7/24

(52) U.S. Cl. CPC H01B 7/08; H01B 7/0225; H01B 7/24

(57) ABSTRACT

A flat cable is provided with cables arranged in parallel in a width direction, and sheaths of the cables adjacent to one another are fused together. The mass of the cable arranged at a center in the width direction is greater than the mass of the cable arranged at edges in the width direction.

### CROSS-REFERENCE TO RELATED APPLICATIONS

The present patent application claims the priority of Japanese patent application No. 2023-018786 filed on Feb. 9, 2023, and the entire contents thereof are hereby incorporated by reference.

### TECHNICAL FIELD

The present invention relates to a flat cable.

### BACKGROUND OF THE INVENTION

Conventionally, a plurality of cables are wired in parallel inside a cable carrier (so-called “cableveyor”: registered trademark) in a movable part of an industrial robot. However, in such a wiring method, the cables wired inside the cable carrier occasionally rubbed against the cable carrier while they were moving and generated powder dust. Therefore, a flat cable with a plurality of cables arranged in parallel without using a cable carrier has been proposed (see, e.g., Patent Literature 1).

### CITATION LIST

Patent Literature Patent Literature 1: JP2013-255419A

### SUMMARY OF THE INVENTION

By the way, a flat cable is wired, for example, in the state where the flat cable is bent into a U-shape and a connecting member such as a connector is attached to the end portion of the flat cable (i.e., cable end portion). In this case, the cable placed at the end of the flat cable in the width direction occasionally hung down, which applied a load to a connecting portion between the cable and the connection member. If the U-shaped bending operation (operation of sliding one end of the cable along the longitudinal direction of the flat cable) was repeated without using the cable carrier in such a state, there may be wire breakage at the connecting portion with the connecting member.

Therefore, the object of the present invention is to provide a flat cable that is hard to break at the cable end portion.

For solving the above problem, the present invention provides a flat cable, comprising: cables arranged in parallel in a width direction, sheaths of the cables adjacent to one another being fused together, wherein a mass of the cable arranged at a center in the width direction is greater than a mass of the cable arranged at edges in the width direction.

### Advantageous Effects of the Invention

According to the present invention, it is possible to provide a flat cable that is hard to break at the cable end portion.

### BRIEF DESCRIPTION OF DRAWINGS

FIG. 1 is a cross-sectional view perpendicular to a longitudinal direction of a flat cable according to an embodiment of the present invention.

FIG. 2 is an explanatory diagram illustrating the wiring condition of the flat cable.

FIG. 3 is an explanatory diagram illustrating the occurrence of wire breakage at the cable end portion.

### DETAILED DESCRIPTION OF THE INVENTION

### Embodiment

Next, an embodiment of the present invention will be explained with reference to appended drawings.

### (Overview of Flat Cable 1)

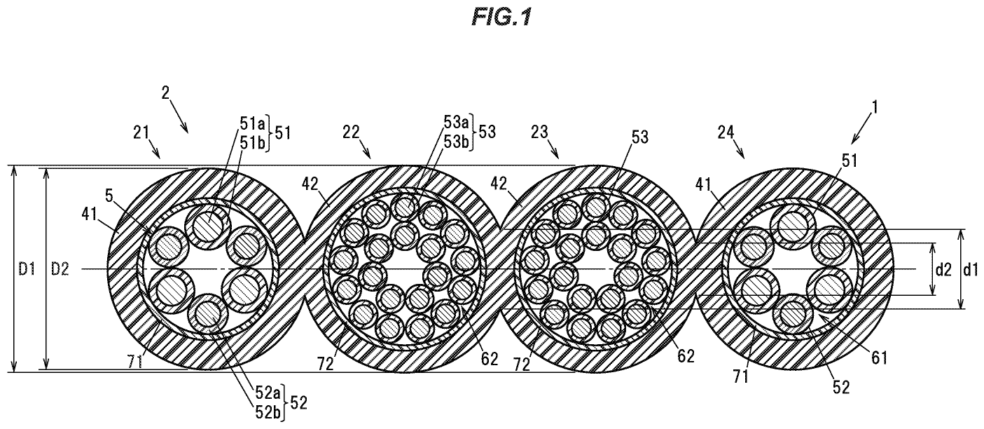

FIG. 1 is a cross-sectional view perpendicular to a longitudinal direction of a flat cable 1 according to an embodiment of the present invention.

As shown in FIG. 1, the flat cable 1 is configured by arranging a plurality of cables 2 in parallel in a width direction. In other words, the width direction of the flat cable 1 is the direction in which the plurality of cables 2 are arranged. Shown here is a case where four cables 21 to 24 are used, but the number of cables 2 is not limited to this. Hereafter, these cables are referred to as a first cable 21, a second cable 22, a third cable 23, and a fourth cable 24 from left to right in FIG. 1.

In the flat cable 1 according to the present embodiment, the cables 2 are fixed to one another by fusing (thermal fusion) sheaths 4 of the cables 2 adjacent to one another in the width direction. Also, in the flat cable 1, the cables are fused in such a manner that the centers of all the cables (centers in a cross-sectional view perpendicular to the longitudinal direction) are aligned. The cables 21 to 24 are described below in details.

### (First Cable 21 and Fourth Cable 24)

The first cable 21 and the fourth cable 24 have two types of electric wires 5 with different outer diameters. More precisely, the first cable 21 and the fourth cable 24 have three first electric wires 51 and three second electric wires 52 whose outer diameters are smaller than those of the first electric wires 51. In other words, each of the cables has six electric wires 5 in total.

The first electric wire 51 has a first conductor 51a which is a stranded wire conductor formed by twisting metal wires made of copper or copper alloy, and a first insulator 51b covering around the first conductor 51a. The second electric wire 52 has a second conductor 52a which is a stranded wire conductor formed by twisting metal wires made of copper or copper alloy, and a second insulator 52b covering around the second conductor 52a. The first insulator 51b and the second insulator 52b are, for example, made of fluororesin, such as polypropylene resin or ETFE (tetrafluoroethylene-ethylene copolymer).

In the first cable 21 and the fourth cable 24, the first electric wire 51 and the second electric wire 52 are arranged alternately in a circumferential direction and twisted together to form a cable core 61. A binder tape 71 is spirally wrapped around the cable core 61. A sheath 41 covers around the binder tape 71. The binder tape 71 is made of a paper tape or a resin tape made of PTFE (polytetrafluoroethylene), nylon, PET (polyethylene terephthalate) or the like. The material of the sheath 41 and other details are described below.

In the present embodiment, the fourth cable 24 has the same structure as that of the first cable 21. However, the present invention is not limited to this and the fourth cable 24 may have a structure different from that of the first cable 21. For example, instead of the first electric wires 51 and the second electric wires 52, coaxial wires or child stranded wires composed of a plurality of electric wires twisted together may be used. In this case, the child stranded wire may be composed of a signal wire(s) and a power wire(s) twisted together. By using the child stranded wires, the plurality of electric wires 5 comprising the cable core 61 are hard to break when the U-shaped bending operation is repeated. As the fourth cable 24, the coaxial wires or the child stranded wires composed of a plurality of wires twisted together may be used for the first cable 21 instead of the first electric wires 51 and the second electric wires 52.

### (Second Cable 22 and Third Cable 23)

The second cable 22 and the third cable 23 have the plurality of electric wires 5. More precisely, the second cable 22 and the third cable 23 have twenty third electric wires 53. The third electric wire 53 has a third conductor 53a that is a stranded wire conductor configured of copper or copper alloy wires stranded together, and a third insulator 53b that covers around the third conductor 53a. The conductor size of the third electric wire 53 is 20 AWG. The third insulator 53b is made of, for example, a polypropylene resin or a fluororesin such as ETFE.

In the second cable 22 and the third cable 23, seven third electric wires 53 are twisted together to form an inner layer, and thirteen third electric wires 53 are stranded around the inner layer to form an outer layer, which makes a double layered cable core 62 with the inner and outer layers. A binder tape 72 made of resin such as PET is spirally wrapped around the cable core 62. A sheath 42 covers around the binder tape 72. The binder tape 72 is made of a paper tape or a resin tape made of PTFE, nylon, PET, or the like. The material of the sheath 42 and other details are described below.

In the present embodiment, the third cable 23 has the same structure as that of the second cable 22. However, the present invention is not limited to this and the third cable 23 may have a different structure from that of the second cable 22. For example, instead of the third electric wires 53, coaxial wires or child stranded wires composed of a plurality of electric wires twisted together may be used. In this case, the child stranded wires may consist of a signal wire(s) and a power wire(s) twisted together. By using the child stranded wires, the plurality of electric wires 5 comprising the cable core 62 are hard to break when the U-shaped bending operation is repeated. Although only one type of wire 5 (third electric wire 53) was used to configure the cable core 62 in the second cable 22 and the third cable 23 here, the cable core 62 may be configured using multiple types of electric wires 5 with different outer diameters, for example.

### (Details of Flat Cable 1)

The flat cable 1 is configured by fusing together the sheaths 41 and 42 of the cables 21 to 24 adjacent to one another. As a method of fusing the sheaths 41 and 42 together, hot air fusion can be used, for example.

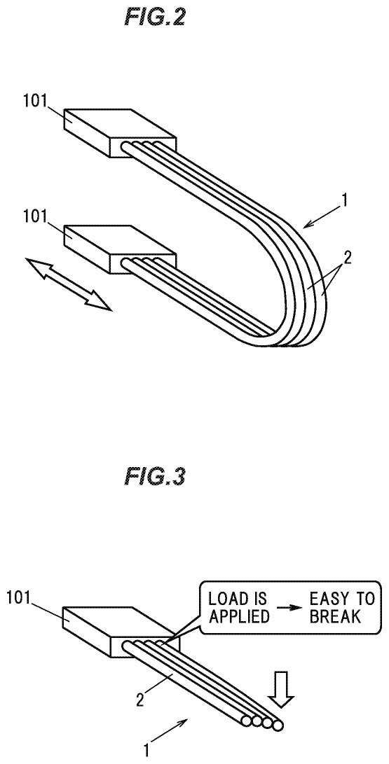

Here, the wiring state of the flat cable 1 is explained. As shown in FIG. 2, the flat cable 1 is wired in a U-shaped bend. A connector 101 is attached at each end of the flat cable 1. One connector 101 is connected, for example, to a fixed part of the mechanism in which the flat cable 1 is installed, and the other connector 101 is connected to a movable part that slides and moves. The movable part slides repeatedly in the longitudinal direction of the flat cable 1. During the sliding operation of the movable part, the flat cable 1 is under an operation (hereinafter referred to as “U-shaped bending operation”) in which one end is fixed in U-shaped bending, while the other end repeatedly slides in the longitudinal direction of the flat cable 1 (white arrow in the drawing).

For the flat cable 1 used in the wiring configuration, as shown in FIG. 2, it is important that the U-shaped bending operation of the flat cable 1 is stable and that the flat cable 1 maintains its U-shaped form and does not hang down.

As explained in FIG. 3, the inventors of the present invention have studied and found that when the cables 2 were heavy, the cables 2 at the end of the flat cable 1 in the width direction hung down and the load was concentrated at the connecting portion between the cables 2 and the connector 101. This occasionally made the cables more tend to break at the connecting portion, i.e., the cable end part. In such a case, it was found that there is a risk of breakage occurring at the cable end part earlier than the design life of the flat cable 1. In order to suppress such a breakage due to cable hanging down at the end of the width direction, ideally, the weight distribution of the cables 2 should be symmetrical with respect to the center of the width direction, so that the center of weight is at the center of the width direction of the flat cable 1.

Therefore, in the present embodiment, the mass of the cables 2 arranged at the center in the width direction (the second cable 22 and the third cable 23) was made greater than the mass of the cables 2 arranged at the edges in the width direction (the first cable 21 and the fourth cable 24). In other words, at least the mass of the cables 2 that constitute the center in the width direction among the cables 2 arranged at the central area in the width direction was made greater than the mass of the cables 2 arranged at the edges in the width direction. More precisely, the mass of the cables 2 arranged at the center in the width direction should be greater than 1.0 times and not more than 2.2 times the mass of the cables 2 arranged at the edges of the width direction. This enables the center of weight to be located close to the center of the flat cable 1 in the width direction (i.e., at the fusion point between the second cable 22 and the third cable 23), and thereby prevents the cables 2 from hanging down at the edges in the width direction and from breakage at the cable end portion. Furthermore, because the center of weight is close to the center of the flat cable 1 in the width direction (i.e., the fusion point between the second cable 22 and the third cable 23), the left and right sides are balanced in the width direction and twisting during the U-shaped bending operation is suppressed. This enables the U-shaped bending operation to be performed in a stable manner. It is more preferable to make the mass of all of the cables 2 arranged at the center in the width direction larger than the mass of the cables 2 arranged at the edges in the width direction. This further suppresses the twisting during the U-shaped bending operation and enables the U-shaped bending operation to be performed in a stable manner.

The “edge in the width direction” refers to the portion at the end of the flat cable 1 in the width direction. The “center in the width direction” refers to a predetermined area that includes the center of the flat cable 1 in the width direction and extends from the center to portions that do not include the edges of the flat cable 1. Furthermore, in the case where the fusion point between the second cable 22 and the third cable 23 is located at the center in the width direction as shown in FIG. 1, “cables that constitute the center of the width direction” refers to the cables 2 that are arranged on both sides of the center (i.e., the second cable 22 and the third cable 23). In a case where the cable 2 is located at the center of the width direction, the cable 2 located at the center shall be the cable that constitutes the center of the width direction.

In the present embodiment, the mass of the second cable 22 and the third cable 23 at the center of the flat cable 1 in the width direction is 120 kg/km or more, and the mass of the first cable 21 and the fourth cable 24 at both edges in the width direction is smaller than that. This prevents the cables 2 from hanging down at the edges in the width direction, and thereby, a breakage at the cable end portions can be suppressed, and the U-shaped bending operation can be performed in a stable manner.

The mass of each cable 2 is obtained, for example, by the following method. First, the flat cable 1 of a predetermined length (1 m) is prepared. In the prepared flat cable 1, the cables 2 adjacent to one another in the width direction at the fusion portion (e.g., the fusion portions of the flat cable 1 shown in FIG. 1) are cut along the longitudinal direction of the flat cable 1 to provide individual cables. Then the mass of each cable 2 is measured using an electronic balance to calculate the mass per kilometer.

Furthermore, in the present embodiment, an outer diameter D1 in the thickness direction of the flat cable 1 (direction perpendicular to the width direction) of the cables 2 (the second cable 22 and the third cable 23) arranged at the center in the width direction is larger than an outer diameter D2 in the thickness direction of the cables 2 (the first cable 21 and the fourth cable 24) arranged at the edges in the width direction. Conventionally, the cables 2 having the same outer diameter are used in the flat cable 1. However, the present embodiment has a structure where the sheath 4 of each cable 2 is adjusted to a predetermined thickness so that the outer diameters of the cables 2 are not the same in the thickness direction of the flat cable 1. This structure enables to reduce the weight of the flat cable 1 and to further suppress hanging down of the cables 2 arranged at the edges in the width direction. In the present embodiment, the outer diameters of the second cable 22 and the third cable 23 at the center of the flat cable 1 in the width direction are 9 mm or more, and the outer diameters of the first cable 21 and the fourth cables 24 at both edges in the width direction are smaller than that.

However, if the outer diameters of the cables 2 are uneven, the symmetry in the width direction may be broken, which may cause a twisting motion during the U-shaped bending operation and destabilize the operation. Therefore, in the present embodiment, the outer diameters of the cables 2 are arranged to be symmetrical with respect to the center of the width direction. In concrete terms, the outer diameters of the second cable 22 and the third cable 23 arranged at the center in the width direction are made equal, and the outer diameters of the first cable 21 and the fourth cables 24 arranged outside of the width direction are made equal, making the distribution of outer diameters symmetrical in the width direction. This enables the U-shaped bending operation to be performed in a stable manner.

Additionally, in the direction of thickness of the flat cable 1, the ratio of the thickness of the sheath 4 to the outer diameters D1 and D2 of each cable 2 is 0.10 or more and 0.20 or less. Also, in the direction of thickness of the flat cable 1, the thickness of the sheath 41 of the first cable 21 and the thickness of the sheath 42 of the second cable 22 are different and the thickness of the sheath 42 of the third cable 23 and the sheath 41 of the fourth cable are different. This configuration of the flat cable 1 allows the mass of the second cable 22 and the third cable 23 arranged at the center in the width direction to be larger than the mass of the first cable 21 and the fourth cable 24 arranged at the edges in the width direction.

Furthermore, the outer diameter of each cable 2 and the thickness of the sheath 4 in the direction of thickness of the flat cable 1 can be measured using a caliper, micrometer, or microscope, with a test method in compliance with JISC3005 or the like, for example.

When fusing the cables 2 with different outer diameters, especially when the cables 2 are center-aligned (the centers of the cables are aligned in the thickness direction), the center of the flat cable 1 in the width direction tends to lift up during the fusing operation. Since the heaviest cables 2 are arranged at the center in the width direction in the present embodiment, it is easier to maintain the flat cable 1 in a flat state, because the gravity suppresses the lifting up of the center in the width direction of the flat cable 1. Therefore, it is particularly easy to fuse the cables 2 with different outer diameters in a center-aligned manner (the centers of the cables are aligned in the thickness direction).

Also, when the connector 101 is installed at the end of the flat cable 1 using the cables 2 with different outer diameters, if a portion of the flat cable 1 to be drawn out from the connector 101 is shaped to follow the outer shape of the flat cable 1, it is less likely for the flat cable 1 to be displaced from the connector 101. This prevents twisting of the flat cable 1 due to displacement of the flat cable 1 from the connector 101. As a result, the U-shaped bending operation can be performed stably over a long period of time.

Furthermore, by using the cables 2 with different outer diameters, the overall width of the flat cable 1 can be reduced, for example, the overall width of the flat cable 1 can be 80 mm or less. This allows terminal connection using the same existing connector 101 as in a case where a conventional cable bear is used.

Also, it is preferable that the fusion area between the second cable 22 and the third cable 23 arranged at the center in the width direction be greater than the fusion area between the first cable 21 or fourth cable 24 and the adjacent second cable 22 or third cable 23 arranged at the edge of the width direction. In other words, in a cross-section perpendicular to the longitudinal direction, the thickness d1 of the fusion area (boundary area) between the second cable 22 and the third cable 23 should be greater than the thickness d2 of the fusion area (boundary area) between the first cable 21 or fourth cable 24 and the adjacent second cable 22 or third cable 23 (see FIG. 1). This can increase the rigidity of the second cable 22 and the third cable 23 which have a large mass, and prevent them from hanging down, making the cables hard to break at the cable end portions.

It is desirable to use a highly elastic material for the sheaths 41 and 42 of the cables 21 to 24 in order to prevent the flat cable 1 from hanging down when wired in a U-shape. In the present embodiment, the tensile strength of the sheaths 41 and 42 of the cables 21 to 24 is 20 MPa or more. This makes it easier to maintain the form of the flat cable 1 wired in a U-shape, and suppresses its hanging down. In addition, because the wired shape of the flat cable 1 can be maintained by setting the tensile strength of the sheaths 41 and 42 to 20 MPa or more, it is also effective for suppressing breakage at the cable ends due to hanging down of the cables 2. The tensile strength can be measured with a method in compliance with the physical properties (ultimate elongation and tensile strength) specified in UL2556.

It is desirable to use a thermally fusible material for the sheaths 41 and 42, for example, they may be composed of a resin composition using polyvinyl chloride resin, a mixed resin of polyvinyl chloride resin and polyurethane resin (high elasticity vinyl), or a mixed resin of fluoro rubber and fluororesin, or the like as a base resin. In the present embodiment, the sheaths 41 and 42 made of a resin composition using a mixed resin of polyvinyl chloride resin and polyurethane resin (high elasticity vinyl) as the base resin, are used. Although all the sheaths 41 and 42 are composed of the same material here, they are not limited to this and may include different materials as long as they are fusion bondable. It is preferable that the thickness of the sheaths 41 and 42 be 0.3 mm or more and 2.0 mm or less. By setting the thickness of the sheaths 41 and 42 to 0.3 mm or more, damage of the sheath 41 and 42 can be suppressed, and by setting the thickness of the sheaths 41 and 42 to 2.0 mm or less, the increase in mass of the flat cable 1 can be suppressed and hanging down of the flat cable 1 can be suppressed.

Although not shown in the figure, the flat cable 1 may be further provided with a plurality of tubes arranged in parallel outward in the width direction from the plurality of cables 2. For example, two tubes of two different types, a total of four tubes, may be further provided. In this case, it is preferable to arrange the tubes symmetrically with respect to the center of the flat cable 1 in the width direction. By providing the tubes, the hanging down of the cable 1 when it is wired in a U-shape can be further suppressed. As a tube, it is preferable to use an air tube made of nylon or the like with high elasticity. When the tubes are provided, it is preferable that the mass of the tubes be less than 1.0 times the mass of the cables 21 and 24 arranged at the edges in the width direction.

### Modified Examples

In the present embodiment, four cables 2 are used, but the number of cables 2 is not limited to this, and three or more cables 2 may be used. In addition to the fact that the number of cables 2 is not limited, the cables 2 may be arranged so that the closer to the center in the width direction the cables 2 are, the larger their mass is (i.e., the outer diameter is larger). For example, in the present embodiment, two cables 2 (i.e., the second cable 22 and the third cable 23) are arranged in parallel at the center of the flat cable 1 in the width direction, but a single cable 2 may be arranged at the center of the flat cable 1 in the width direction, and one cable 2 may be arranged at each edge in the width direction. Also, three or more cables 2 may be arranged in parallel at the center of the flat cable 1 in the width direction and one cable 2 may be arranged at each edge in the width direction.

Furthermore, in the present embodiment, the sheaths 41 and 42 are configured with a single layer, but they may be multi-layered. For example, the sheaths 41 and 42 may be configured with two layers, an inner layer and an outer layer, and the outer layers may be fused together to form the flat cable 1.

### Advantageous Effects of the Embodiment

As explained above, the flat cable 1 according to the present embodiment is configured by arranging a plurality of cables 2 in parallel in the width direction and by fusing together the sheaths 4 of the cables 2 adjacent to one another. The mass of the cables 2 arranged at the center in the width direction is greater than that of the cables 2 arranged at the edges in the width direction.

This configuration can suppress the hanging down of the cable 1 at the edge in the width direction and realize the flat cable 1 that is hard to break at the cable end portion.

### Summary of the Embodiment

Next, technical ideas understood from the above embodiment, are described with reference to the reference numerals and the like used in the embodiment. However, each reference numeral in the following description does not limit the constituent elements in the scope of claims to the members and the like specifically shown in the embodiments.

According to the first feature, a flat cable 1 is configured by arranging a plurality of cables 2 in parallel in the width direction and by fusing together sheaths 4 of the cables 2 adjacent to one another, and the mass of the cables 2 arranged at the center in the width direction is greater than the mass of the cables 2 arranged at the edges in the width direction.

According to the second feature, in the flat cable 1 as described in the first feature, the mass of the cable 2 located at the center in the width direction is greater than 1.0 times and not greater than 2.2 times the mass of the cable 2 located at the edges in the width direction.

According to the third feature, in the flat cable 1 as described in the first feature, the tensile strength of the sheath 4 of each cable 2 is 20 MPa or more.

According to the fourth feature, in the flat cable 1 as described in the second feature, the outer diameter in the direction orthogonal to the width direction of the cable 2 arranged at the center in the width direction is larger than the outer diameter in the direction orthogonal to the width direction of the cable 2 arranged at the edges in the width direction.

According to the fifth feature, in the flat cable 1 as described in the fourth feature, the outer diameters of the cables 2 are set to be symmetrical with respect to the center in the width direction.

According to the sixth feature, the flat cable 1 as described in the first feature further includes a plurality of tubes that are arranged in parallel outward in the width direction from the plurality of cables 2 as well as arranged symmetrically with respect to the center in the width direction.

The above description of the embodiments of the invention does not limit the invention as claimed above. It should also be noted that not all of the combinations of features described in the embodiments are essential to the means for solving the problems of the invention. In addition, the invention can be implemented with appropriate modifications to the extent that it does not depart from the gist of the invention.

1. A flat cable, comprising:
cables arranged in parallel in a width direction, sheaths of the cables adjacent to one another being fused together,
wherein a mass of the cable arranged at a center in the width direction is greater than a mass of the cable arranged at edges in the width direction.

2. The flat cable according to claim 1, wherein the mass of the cable arranged at the center in the width direction is greater than 1.0 times and not greater than 2.2 times the mass of the cable arranged at the edges in the width direction.

3. The flat cable according to claim 1, wherein a tensile strength of the sheath of each of the cables is 20 MPa or more.

4. The flat cable according to claim 1, wherein an outer diameter D1 in a direction orthogonal to the width direction of the cable arranged at the center in the width direction is larger than an outer diameter D2 in a direction orthogonal to the width direction of the cable arranged at the edges of the width direction.

5. The flat cable according to claim 4, wherein outer diameters of the cables are set to be symmetrical with respect to the center of the width direction.

6. The flat cable according to claim 1, further comprising:
tubes arranged in parallel outwardly in the width direction from the cables, as well as arranged symmetrically with respect to a center in the width direction.
